(19) United States
(12) Patent Application Publication
(10) Pub. No.: US 2016/0028857 A1
(43) Pub. Date: Jan. 28, 2016

(54) FRAMEWORK FOR CLIENT-SERVER APPLICATIONS USING REMOTE DATA BINDING

(71) Applicant: Synchro Labs, Inc., Redmond, WA (US)

(72) Inventor: Robert Deming Dickinson, III, Redmond, WA (US)

(73) Assignee: Synchro Labs, Inc., Redmond, WA (US)

(21) Appl. No.: 14/444,117

(22) Filed: Jul. 28, 2014

(51) Int. Cl. H04L 29/06

(52) U.S. Cl. CPC H04L 67/42

(57) ABSTRACT

Embodiments are directed towards a framework for building client-server applications. A server may provide a view definition to a client based on a page request. The view definition may define a view, and relationships between view elements and view manager elements. The client may locally bind user input associated with at least one view element to at least one view manager element based on the relationships. The bound view manager element may be provided from the client to the server based on explicit or implicit synchronization conditions. A view manager on the server may determine a result based on the bound view manager element. The client may locally bind the result associated with another view manager element to another view element based on the relationship. The client may update the view based on the bound other view element.

### TECHNICAL FIELD

The present invention relates generally to applications, and more particularly, but not exclusively, to providing a framework for building client-server applications, where logic of the application executes on a server device while the client device provides a view of the application to a user.

### BACKGROUND

Today, mobile applications come in a variety of shapes, sizes, and functionality. They are often designed to run on a variety of different types of mobile devices with varying capabilities (e.g., different operating systems and/or versions of operating systems, screen size, memory limits/utilization, and the like), which is commonly referred to as device fragmentation. Mobile applications are typically made for a particular device type with particular capabilities. If the application is to be supported by different device types with different capabilities, then the application may be converted or modified to be compatible with these different devices. However, getting an application to execute properly on each device type may be difficult, time consuming, and expensive.

If a developer or administrator makes a change to one of these mobile applications, then the change typically needs to be made for each supported device type. However, due to the extent of device fragmentation, managing just one mobile application, let alone multiple applications, may be difficult, time consuming, and expensive for most application developers. Moreover, users may have to download and install a new version of the application to be able to use the changed application. However, some users may not perform the download. So, the application developer may have to provide maintenance for multiple versions of the application for each supported device type, which can result in even more expense to the application developer. Thus, it is with respect to these considerations and others that the invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client computer that may be included in a system such as that shown in FIG. 1;

FIG. 3 illustrates an embodiment of a network computer that may be included in a system such as that shown in FIG. 1;

FIG. 4 illustrates an embodiment of a system diagram of a framework to enable a client computer to provide a view of an application that is executing on a server computer;

FIG. 5 illustrates an alternative embodiment of a system diagram of a framework to enable a client computer to provide a view of an application that is executing on a server computer;

FIG. 6 illustrates a logical flow diagram generally showing one embodiment of an overview process for enable a client computer to provide a view of an application that is executing on a server computer;

FIG. 7 illustrates a logical flow diagram generally showing one embodiment of a process for initializing a client session with a server and providing a view definition to the client;

FIG. 8 illustrates a logical flow diagram generally showing one embodiment of a process for enabling remote data binding between view elements on the client and view manager elements on the server;

FIG. 9 illustrates a logical flow diagram generally showing one embodiment of a process for enabling a view manager proxy to provide controlled synchronization of remote data binding between view elements on the client and view manager elements on the server; and

FIGS. 10A-10B show a use case example embodiment of code that may be employed to provide remote data binding.

### DETAILED DESCRIPTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may be entirely hardware embodiments, entirely software embodiments, or embodiments combining software and hardware aspects. The following detailed description should, therefore, not be limiting.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “view” may refer to the elements displayed by a graphical user interface. These elements may be referred to as “view elements” and may include, but are not limited to, text, text boxes, pull-down lists, icons, command buttons, edit controls, radio buttons, other commands/controls, or the like. View elements may also include other user interface components of a device, such as, but not limited to, platform-specific navigation buttons, other physical buttons and/or controls of the client computer, or the like.

As used herein, the term “page” may refer to a unit of functionality of an application. An application may be a single page or a plurality of pages. A page may include at least one view definition. In some embodiments, a page may include a plurality of view definitions, where each view definition may be tailored for a specific platform (e.g., a particular type of client computer with particular capabilities). In this way, one view definition may employ native controls of one device, another view definition may employ native controls of a different device, and so on. In various embodiments, a page may also include a view manager.

As used herein, the term “view definition” may refer to a specification that defines any view elements to be displayed on the client computer. The view definition may also describe relationships between view elements on the client computer and view manager elements of a view manager executing on a server computer, which may enable data binding to occur between view elements and view manager elements. In various embodiments, a view definition may also include conditions for triggering the synchronization of the data binding between the client computer and the server computer. If the condition is satisfied, then the client computer may synchronize data between the client computer and the server computer. For example, the client computer may maintain a state of the data bound view manager elements, and may provide those to the server computer when a predetermined command is provided (e.g., the user clicks a button). In this case, the data binding may have occurred locally on the client computer, but is not synchronized or provided to the server computer until a specific action occurs. The view definition may also be referred to as a view specification with a description of the view and the relationships between view elements and view manager elements.

As used herein, the term “view manager” may refer to a module or component that manages and/or performs at least some of actions associated with the functionality of the application. The view manager may include at least one view manager element. View manager elements may include variables, logic, or the like. In various embodiments, the view manager may implement a combination of interaction logic and business logic to provide a complete application experience on the client computer. The interaction logic may include user interface actions/controls, such as, for example, when a user clicks button A, perform this action; or if the user changes this value, update that control; or the like. The business logic or “model” may perform other application-related actions, such as, for example, authentication, database access, access to other services, codified business rules, or the like. In various different presentation architectures, the view manager may also be referred to as a ViewModel (in MVVM—Model, View, ViewModel), a Presenter (in MVP—Model, View, Presenter), a Controller (in MVC—Model, View, Controller), or the like.

As used herein, the term “data binding” may refer to linking of data, values, controls, notifications, or the like from at least one view element to at least one view manager element where there is a defined relationship between the view element and the view manager element, such that an update or change to one element automatically establishes an update or change to another linked/related element. So data binding may be the linking or relationship between view elements (associated with a view on a client computer) and view manager elements (associated with a view manager on a server computer). For example, assume data binding between view_element_A and view_manager_element_B (and that the relationship between the two elements is a two-way relationship). An update to view_element_A may automatically establish, trigger, or generate an update to view_manager_element_B. Similarly, an update to view_manager_element_B may automatically establish, trigger, or generate an update to view_element_A. In some embodiments, the automatically established update may be the same update (data, command, notification, or the like) as the initiating update. In other embodiments, the automatically established update may be based on an initiating update, a subset of the initiating update, derived from the initiating update, or the like. So in general, binding may establish, trigger, or generate automatic, from the perspective of the application code, updates between elements (e.g., view elements and view manager elements).

Data binding may include the binding of data, controls, notifications, or the like between view elements and view manager elements. In various embodiments, data binding may bind a data value of a view element to be the value of a view manager element. In other embodiments, data binding may bind a command associated with a view element to a command of a view manager element. In yet other embodiments, data binding may include providing a notification to a view manager element based on a value, action, change of status, or the like of a view element.

Data binding relationships may be one-to-one, one-to-many, many-to-one, or many-to-many between view elements and view manager elements. In a one-to-one relationship one view element may be data bound to one view manager element. For example, a command button (one view element) may be bound to a single command variable (one view manager element). In a one-to-many relationship, one view element may be data bound to a plurality of view manager elements. For example, a list (one view element) may be bound to a list and current selection variable (multiple view manager elements). In a many-to-one relationship a plurality of view elements may be data bound to one view manager element. For example, an increment button and a decrement button (multiple view elements) may be bound to a value update command (one view manager element). And in a many-to-many relationship a plurality of view elements may be data bound to a plurality of view manager elements. For example, a plurality of check boxes (multiple view elements) may be bound to a plurality of action commands (multiple view manager elements).

Data binding may be referred to as “local data binding,” “local binding,” or “locally binding” because the binding may occur on a client computer prior to providing the bound data/commands to a server or after receiving data/commands from the server. For example, the client computer may locally bind, i.e., on the client computer, an update to view_element_A with a corresponding update to view_manager_element_A. The client computer may then provide the updated view_manager_element_A to a server computer. So, the binding occurs on the client computer. Similarly, the client computer may receive data/command for view_manager_element_B. The client computer may locally bind the updated view_manager_element_B with a corresponding update to view_element_B.

In some embodiments, data binding may include two-way binding (or two-way relationships) or one-way binding (or one-way relationships). Two-way binding may be such that the view element and the view_manager_element are synchronized such that a change in one is reflected by a similar or same change in the other. For example, an edit control may be a two-way relationship, where a user can see and edit text, and that text is synchronized with a string variable or member in the view manager (i.e., view_manager_element), and when the view manager modifies the view_manager_element, it will be synchronized with the view, and the edit control will be updated to reflect the new value. Another example of a two-way relationship may be a list control in the view where the contents of the list control (i.e., a view element) may be linked to a list object in the view manager (i.e., a view_manager_element), and the current selected item in the list control may be linked to a different variable or member in the view manager. It should be recognized that these examples are for illustration purposes and other two-way binding relationships may be employed.

One-way data binding may be when data from a view manager populates some property or attribute of a user interface control (i.e., a view element) in the view. For example, the position of a control on the screen (e.g., (x,y) coordinates), whether the control is enabled or visible, what color it is, what font is used, or the like, could be controlled by data/controls from a view manager. In some embodiments, this relationship may be specified to be “one time,” in that the value in the view may be initialized from the view manager when the view is initially rendered, but no further synchronization may occur. It should be recognized that these examples are for illustration purposes and other one-way binding relationships may be employed.

Briefly stated, embodiments are directed to employing a framework for providing an application view on a client computer while the application is executing on a server computer. Sometimes, mobile applications access databases and other information on server computers. Some of these client-server application may be employed through an application architecture often known as presentation design patterns. These architectures can include MVVM (Model, View, ViewModel), MVP (Model, View, Presenter), MVC (Model, View, Controller), and other variations. The functional implementation of a presentation design pattern (i.e., the actual running code that provides the functions and services necessary to support the design pattern) may be sometimes referred to as an application or presentation framework. These patterns and frameworks may be used to create software applications on client computers or platforms with which users interact, where the resulting application runs on the client computer.

Typically, these presentation design patterns separate the presentation of user interface from the underlying application logic, business logic, or data. An element known as a view may represent the interface that the user sees and interacts with, and an element known as a model may be composed of the underlying application logic, business logic, or data. Sometimes, an intermediate layer or component may bridge between the view and the model, allowing them to be abstracted from each other. Abstracting the view from the model has a number of benefits, including, but not limited to, making it easier to develop and maintain applications, and making those applications more robust and secure.

Embodiments described herein employ a framework for providing a computer application for a client computer. Although embodiments may primarily be described herein as a framework for providing applications, embodiments are not so limited and other types of client-server applications (e.g., browser-based applications, native Windows or Mac OS applications, or the like) may also be built and provided through the disclosed framework.

A client computer may establish a session between the client computer and the server computer, which may include providing, to the server computer, characteristics of the client computer. The client computer may then provide a page request for a view definition to the server computer. In some embodiments, this page request may be initiated by a user of the client computer.

A server computer may provide a view definition to the client computer. The view definition may define a view that includes a plurality of view elements. And the view definition may define at least one relationship between the plurality of view elements and a plurality of view manager elements of a view manager executing on the server computer. In some embodiments, the server computer may filter/modify/or adjust the view definition based on various criteria (e.g., characteristics of the client computer, user preferences, previously provided information, or the like). In other embodiments, the server computer may determine a version of the view definition from a plurality of view definitions based on characteristics of the client computer, where the determined view definition version is provided to the client computer.

The client computer may render the view on the client computer based at least on the view definition. In some embodiments, the server computer may provide a view initialization for the page to the client computer so the client computer can render an initial view. The client computer may locally bind user input associated with at least one of the plurality of view elements to at least one of the plurality of view manager elements based on the at least one defined relationship. In various embodiments, the binding may include at least one of data, commands, or notifications.

In some embodiments, the client computer may maintain a local state of the view manager on the client computer based on the at least one view_manager_element. In various embodiments, the view definition may include at least one condition for triggering the client computer to provide the user input bound to the at least one view_manager_element from the client computer to the server computer. For example, in some embodiments, the view definition may include conditions for triggering synchronization of the local state and a server state of the view manager on the server computer. In response to a synchronization condition being satisfied, the client computer may synchronize the local state with the server state of the view manager on the server computer.

The view manager on the server computer may perform actions and determine a result based on the at least one view manager element. In some embodiments, the view manager may utilize a model to determine at least a portion of the result based on the at least one view manager element. The result may be associated with at least one other view manager element. In some embodiments, the result may include a request for another view definition to be provided to the client computer.

The client computer may locally bind the result associated with the at least one other view manager element to at least one other view element based on the at least one defined relationship. The client computer may update the view on the client computer based on the at least one other view element.

### Illustrative Operating Environment

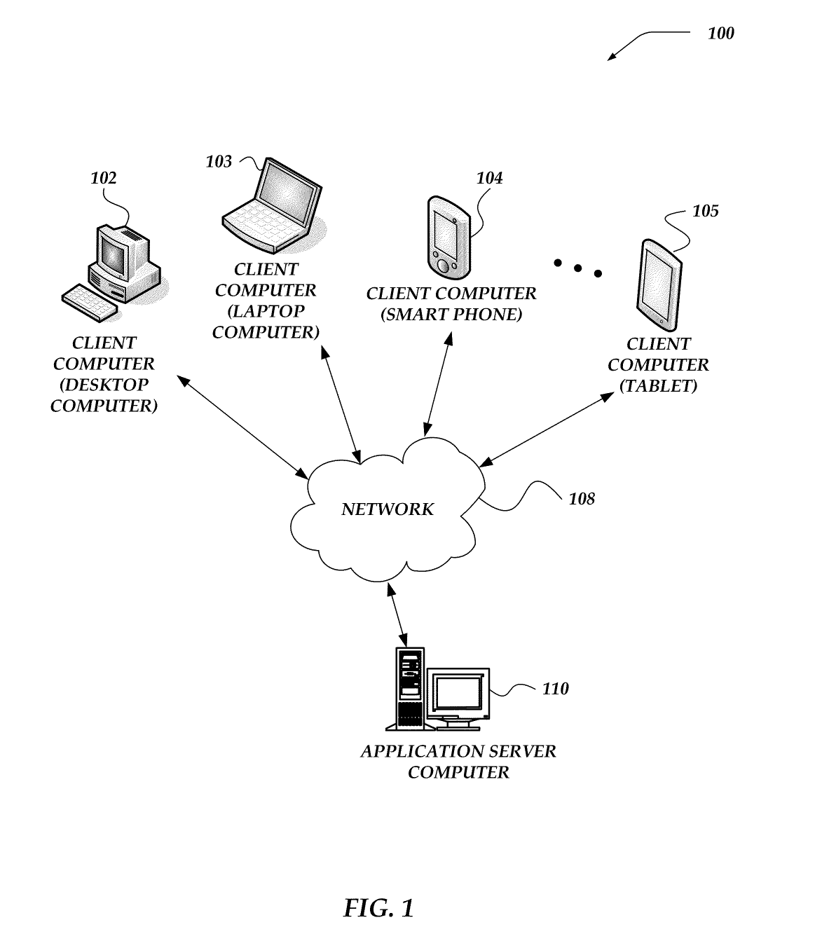

FIG. 1 shows components of one embodiment of an environment in which various embodiments of the invention may be practiced. Not all of the components may be required to practice the various embodiments, and variations in the arrangement and type of the components may be made without departing from the spirit or scope of the invention. As shown, system 100 of FIG. 1 may include application server computer (ASC) 110, client computers 102-105, and network 108.

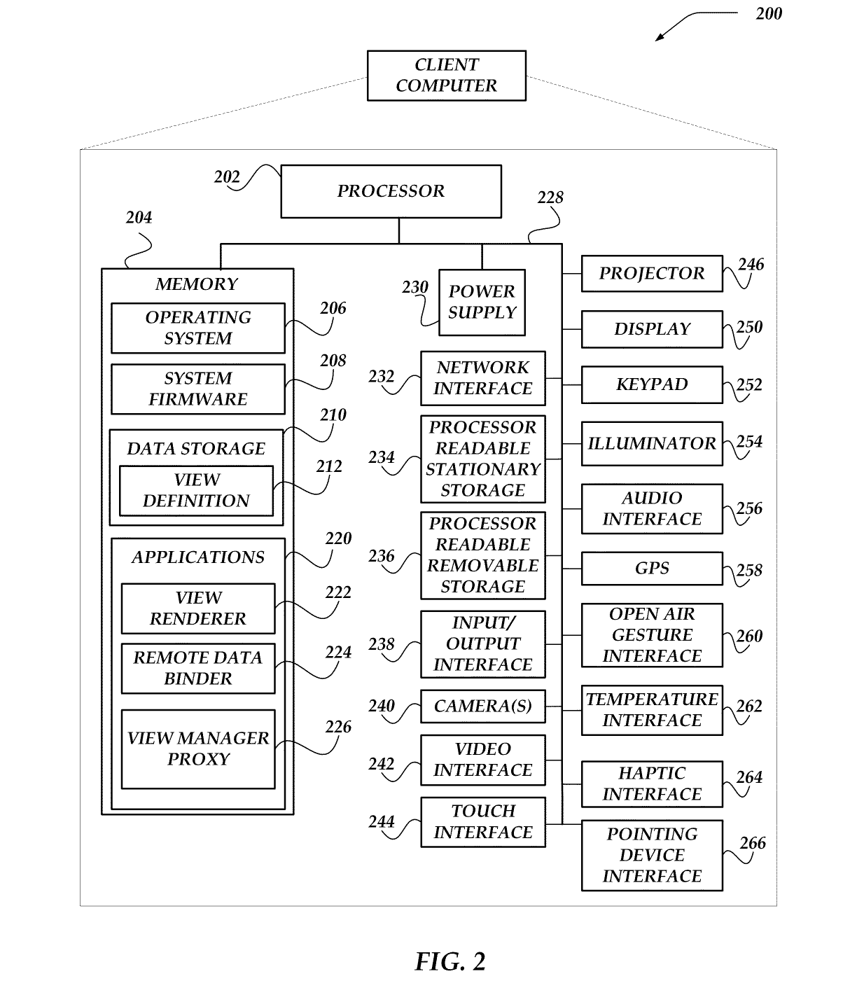

At least one embodiment of client computers 102-105 is described in more detail below in conjunction with client computer 200 of FIG. 2. Briefly, in some embodiments, client computers 102-105 may be configured to communicate with ASC 110 and/or other network computers.

In some embodiments, at least some of client computers 102-105 may operate over a wired and/or wireless network to communicate with other computing devices or ASC 110. Generally, client computers 102-105 may include computing devices capable of communicating over a network to send and/or receive information, perform various online and/or offline activities, or the like. It should be recognized that embodiments described herein are not constrained by the number or type of remote computers employed, and more or fewer remote computers—and/or types of remote computers—than what is illustrated in FIG. 1 may be employed.

Devices that may operate as client computers 102-105 may include various computing devices that typically connect to a network or other computing device using a wired and/or wireless communications medium. Client computers 103-105 may be mobile devices and may include portable computers, and client computer 102 may include non-portable computers. Examples of client computer 102 may include, but is not limited to, desktop computers, personal computers, multiprocessor systems, microprocessor-based or programmable electronic devices, network PCs, or the like, or integrated devices combining functionality of one or more of the preceding devices. Examples of client computers 103-105 may include, but are not limited to, laptop computers (e.g., client computer 103), smart phones (e.g., client computer 104), tablet computers (e.g., client computer 105), cellular telephones, display pagers, Personal Digital Assistants (PDAs), handheld computers, wearable computing devices, or the like, or integrated devices combining functionality of one or more of the preceding devices. As such, client computers 102-105 may include computers with a wide range of capabilities and features.

Client computers 102-105 may access and/or employ various computing applications to enable users to perform various online and/or offline activities. Such activities may include, but are not limited to, generating documents, gathering/monitoring data, capturing/manipulating images, managing media, managing financial information, playing games, managing personal information, browsing the Internet, or the like. In some embodiments, client computers 102-105 may be enabled to connect to a network through a browser, or other web-based application.

Client computers 102-105 may further be configured to provide information that identifies the client computer. Such identifying information may include, but is not limited to, a type, capability, configuration, name, or the like, of the remote computer. In at least one embodiment, a remote computer may uniquely identify itself through any of a variety of mechanisms, such as an Internet Protocol (IP) address, phone number, Mobile Identification Number (MIN), media access control (MAC) address, electronic serial number (ESN), or other device identifier.

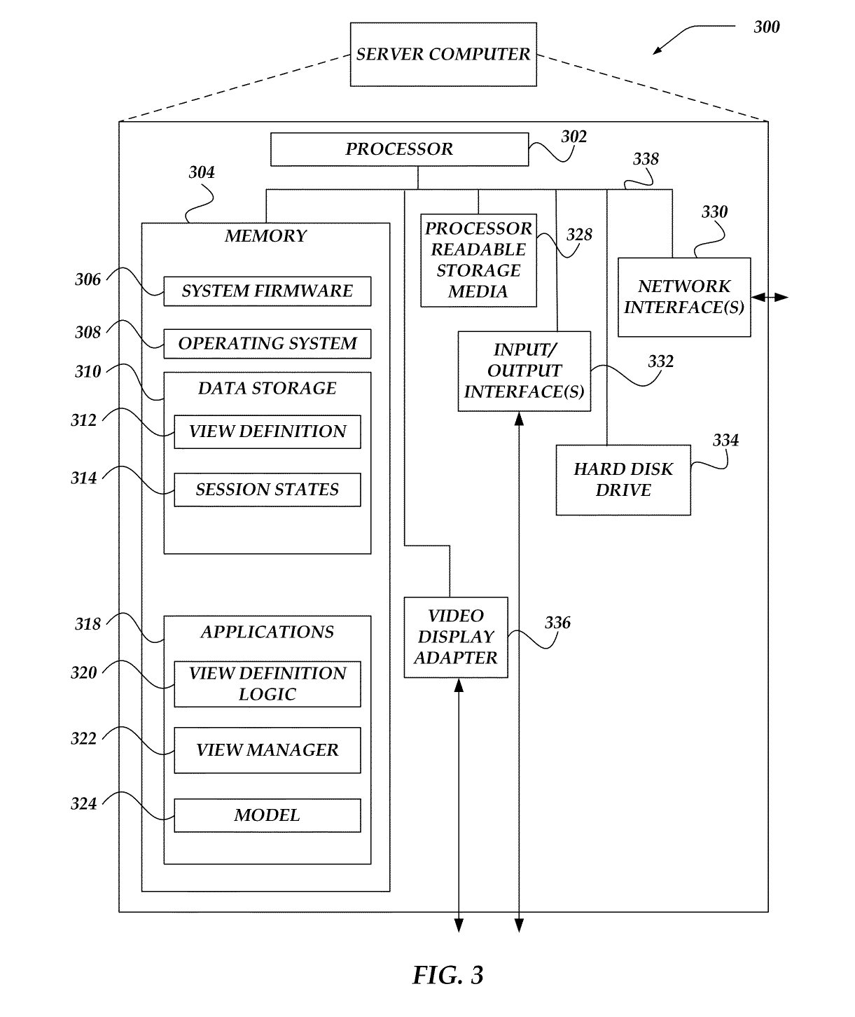

At least one embodiment of ASC 110 is described in more detail below in conjunction with server computer 300 of FIG. 3. Briefly, in some embodiments, ASC 110 may be operative to communicate with client computers 102-105 to enable applications to run on ASC 110 but acts like an application running on the client computer via a “shell” application executing on the client computer.

Network 108 may include virtually any wired and/or wireless technology for communicating with a remote device, such as, but not limited to, USB cable, Bluetooth, Wi-Fi, or the like. In some embodiments, network 108 may be a network configured to couple network computers with other computing devices, including client computers 102-105, ASC 110, or the like. In various embodiments, information communicated between devices may include various kinds of information, including, but not limited to, processor-readable instructions, remote requests, server responses, program modules, applications, raw data, control data, system information (e.g., log files), video data, voice data, image data, text data, structured/unstructured data, or the like. In some embodiments, this information may be communicated between devices using one or more technologies and/or network protocols.

In some embodiments, such a network may include various wired networks, wireless networks, or any combination thereof. In various embodiments, the network may be enabled to employ various forms of communication technology, topology, computer-readable media, or the like, for communicating information from one electronic device to another. For example, the network can include—in addition to the Internet—LANs, WANs, Personal Area Networks (PANs), Campus Area Networks (CANs), Metropolitan Area Networks (MANs), direct communication connections (such as through a universal serial bus (USB) port), or the like, or any combination thereof.

In various embodiments, communication links within and/or between networks may include, but are not limited to, twisted wire pair, optical fibers, open air lasers, coaxial cable, plain old telephone service (POTS), wave guides, acoustics, full or fractional dedicated digital lines (such as T1, T2, T3, or T4), E-carriers, Integrated Services Digital Networks (ISDNs), Digital Subscriber Lines (DSLs), wireless links (including satellite links), or other links and/or carrier mechanisms known to those skilled in the art. Moreover, communication links may further employ any of a variety of digital signaling technologies, including without limit, for example, DS-0, DS-1, DS-2, DS-3, DS-4, OC-3, OC-12, OC-48, or the like. In some embodiments, a router (or other intermediate network device) may act as a link between various networks—including those based on different architectures and/or protocols—to enable information to be transferred from one network to another. In other embodiments, remote computers and/or other related electronic devices could be connected to a network via a modem and temporary telephone link. In essence, the network may include any communication technology by which information may travel between computing devices.

The network may, in some embodiments, include various wireless networks, which may be configured to couple various portable network devices, remote computers, wired networks, other wireless networks, or the like. Wireless networks may include any of a variety of sub-networks that may further overlay stand-alone ad-hoc networks, or the like, to provide an infrastructure-oriented connection for at least client computer 103-105 (or other mobile devices). Such sub-networks may include mesh networks, Wireless LAN (WLAN) networks, cellular networks, or the like. In at least one of the various embodiments, the system may include more than one wireless network.

The network may employ a plurality of wired and/or wireless communication protocols and/or technologies. Examples of various generations (e.g., third (3G), fourth (4G), or fifth (5G)) of communication protocols and/or technologies that may be employed by the network may include, but are not limited to, Global System for Mobile communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000 (CDMA2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), time division multiple access (TDMA), Orthogonal frequency-division multiplexing (OFDM), ultra wide band (UWB), Wireless Application Protocol (WAP), user datagram protocol (UDP), transmission control protocol/Internet protocol (TCP/IP), any portion of the Open Systems Interconnection (OSI) model protocols, session initiated protocol/real-time transport protocol (SIP/RTP), short message service (SMS), multimedia messaging service (MMS), or any of a variety of other communication protocols and/or technologies. In essence, the network may include communication technologies by which information may travel between client computers 102-105, ASC 110, other computing devices not illustrated, other networks, or the like.

In various embodiments, at least a portion of the network may be arranged as an autonomous system of nodes, links, paths, terminals, gateways, routers, switches, firewalls, load balancers, forwarders, repeaters, optical-electrical converters, or the like, which may be connected by various communication links. These autonomous systems may be configured to self organize based on current operating conditions and/or rule-based policies, such that the network topology of the network may be modified.

### Illustrative Client Computer

FIG. 2 shows one embodiment of client 200 that may include many more or less components than those shown. Client computer 200 may represent, for example, at least one embodiment of client computers 102-105 shown in FIG. 1. So, client computer 200 may be a mobile device (e.g., a smart phone or tablet), a stationary/desktop computer, or the like.

Client computer 200 may include processor 202 in communication with memory 204 via bus 228. Client computer 200 may also include power supply 230, network interface 232, processor-readable stationary storage device 234, processor-readable removable storage device 236, input/output interface 238, camera(s) 240, video interface 242, touch interface 244, projector 246, display 250, keypad 252, illuminator 254, audio interface 256, global positioning systems (GPS) receiver 258, open air gesture interface 260, temperature interface 262, haptic interface 264, pointing device interface 266, or the like. Client computer 200 may optionally communicate with a base station (not shown), or directly with another computer. And in one embodiment, although not shown, an accelerometer or gyroscope may be employed within client computer 200 to measuring and/or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling client computer 200 to one or more networks, and is constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the mobile device is powered. Also, illuminator 254 may backlight these buttons in various patterns when particular actions are performed, such as dialing another mobile computer. Illuminator 254 may also cause light sources positioned within a transparent or translucent case of the mobile device to illuminate in response to actions.

Client computer 200 may also comprise input/output interface 238 for communicating with external peripheral devices or other computers such as other mobile computers and network computers. Input/output interface 238 may enable client computer 200 to communicate with one or more application servers, such as ASC 110 of FIG. 1. Other peripheral devices that client computer 200 may communicate with may include remote speakers and/or microphones, headphones, display screen glasses, or the like. Input/output interface 238 can utilize one or more technologies, such as Universal Serial Bus (USB), Infrared, Wi-Fi, WiMax, Bluetooth™, wired technologies, or the like.

Haptic interface 264 may be arranged to provide tactile feedback to a user of a client computer. For example, the haptic interface 264 may be employed to vibrate client computer 200 in a particular way when another user of a computer is calling. Temperature interface 262 may be used to provide a temperature measurement input and/or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of mobile device 200 on the surface of the Earth. It is understood that under different conditions, GPS transceiver 258 can determine a physical location for mobile device 200. In at least one embodiment, however, client computer 200 may, through other components, provide other information that may be employed to determine a physical location of the mobile computer, including for example, a Media Access Control (MAC) address, IP address, and the like.

Human interface components can be peripheral devices that are physically separate from client computer 200, allowing for remote input and/or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a mobile computer with such peripheral human interface components is a wearable computer, which might include a remote pico projector along with one or more cameras that remotely communicate with a separately located mobile computer to sense a user's gestures toward portions of an image projected by the pico projector onto a reflected surface such as a wall or the user's hand.

A client computer may include a browser application that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules or other data. Memory 204 may store system firmware 208 (e.g., BIOS) for controlling low-level operation of client computer 200. The memory may also store operating system 206 for controlling the operation of client computer 200. It will be appreciated that this component may include a general-purpose operating system such as a version of UNIX, or LINUX™, or a specialized mobile computer communication operating system such as Windows Phone™, or the Symbian® operating system. The operating system may include, or interface with a Java virtual machine module that enables control of hardware components and/or operating system operations via Java application programs.

Memory 204 may further include one or more data storage 210, which can be utilized by client computer 200 to store, among other things, applications 220 and/or other data. For example, data storage 210 may also be employed to store information that describes various capabilities of client computer 200. The information may then be provided to another device or computer based on any of a variety of events, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the mobile device.

Data storage 210 may view definition 212 or other data files. View definition 212 may include one or more view definitions that defines the specification of any controls/view elements to be displayed on the client computer and how those view elements relate to view manager elements of a view manager on a server computer (e.g., ASC 110 of FIG. 1).

Applications 220 may include computer executable instructions which, when executed by client computer 200, transmit, receive, and/or otherwise process instructions and data. Examples of application programs include, but are not limited to, calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. In some embodiments, applications 220 may also include view renderer 222, remote data binder 224, and/or view manager proxy 226. View renderer 222 and remote data binder 224 may be modules, components, logic, or the like of a single program executing on client computer 200 or may be separate programs executing on client computer 200. View renderer 222 and view manager proxy 226 may be modules, components, logic, or the like of a single program executing on client computer 200 or may be separate programs executing on client computer 200.

View renderer 222 may be executing on client computer 200 and may receive the view definition from a server (e.g., ASC 110 of FIG. 1). View renderer 222 may employ the view definition to render or otherwise provide a graphical user interface to a user of client computer 200, which may include native controls to represent the view—as defined by the view definition received from the server computer—on the client computer.

Remote data binder 224 may be executing on client computer 200 and may manage relationships between view elements and view manager elements, as defined by view definition 212. Remote data binder 224 allows for complete separation of the view and the view manager, such that the view manager (i.e., view manager 322 of FIG. 3) can be implemented on the server (e.g., server computer 300 of FIG. 3).

View manager proxy 226 may be executing on client computer 200 and may manage relationships between view elements and view manager elements, as defined by view definition 212, similar to remote data binder 224. View manager proxy 226 may also maintain a current view manager state on client computer 200, which may be referred to as the client state or current client. View manager proxy 226 may synchronize the client state with the view manager state maintained on a server computer (e.g., server computer 300 of FIG. 3) as needed. Each data binding condition (in the view definition) can include information as to when specific data changes may be provided to the server (e.g., the server may need those changes to perform some action). These conditions may trigger and/or otherwise indicate on what basis, and in response to what user actions, timeouts, or other events, should data be synchronized between the client computer and the server computer.

Moreover, view manager proxy 226 may employ characteristics of the view manager on the server to automatically determine what data should be synchronized and on what basis. In various embodiments, synchronizing the data as-needed can reduce an amount of data sent back and forth between the client computer and the server computer, which can improve responsiveness of the application to the user.

### Illustrative Network Device

FIG. 3 shows one embodiment of a server computer 300, according to one embodiment of the invention. Server computer 300 may include many more or less components than those shown. The components shown, however, are sufficient to disclose an illustrative embodiment for practicing the invention. Server computer 300 may represent, for example ASC 110 of FIG. 1.

Server computer 300 includes processor 302, processor readable storage media 328, network interface unit 330, an input/output interface 332, hard disk drive 334, video display adapter 336, and memory 304, all in communication with each other via bus 338. In some embodiments, processor 302 may include one or more central processing units.

As illustrated in FIG. 3, server computer 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Server computer 300 also comprises input/output interface 332 for communicating with external devices, such as a keyboard or other input or output devices not shown in FIG. 3. Input/output interface 332 can utilize one or more communication technologies, such as USB, infrared, Bluetooth™, or the like.

Memory 304 generally includes RAM, ROM and one or more permanent mass storage devices, such as hard disk drive 334, tape drive, optical drive, and/or floppy disk drive. Memory 304 stores operating system 308 for controlling the operation of server computer 300. Any general-purpose operating system may be employed. System firmware 306 is also provided for controlling the low-level operation of server computer 300 (e.g., BIOS).

Although illustrated separately, memory 304 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 304 further includes one or more data storage 310, which can be utilized by server computer 300 to store, among other things, applications 318 and/or other data. For example, data storage 310 may also be employed to store information that describes various capabilities of server computer 300. The information may then be provided to another device based on any of a variety of events, including being sent as part of a header during a communication, sent upon request, or the like.

Data storage 310 may also include a database, text, spreadsheet, folder, file, or the like, that may be configured to maintain and store user account identifiers, user profiles, email addresses, IM addresses, and/or other network addresses; or the like. Data storage 310 may further include program code, data, algorithms, and the like, for use by a processor, such as processor 302 to execute and perform actions. In one embodiment, at least some of data store 310 might also be stored on another component of server computer 300, including, but not limited to processor-readable storage media 328, hard disk drive 334, or the like.

Data storage 310 may include view definition 314 and/or session states 314. View definition 314 may include one or more view definitions for one or more separate pages, which can be provided to a client device (e.g., client computer 200 of FIG. 2). Server computer 300 may provide a view definition 312 to a client computer upon request for a particular page, as described herein. Session states 314 may include one or more view manager states for each session with each client computer. So, server computer 300 may maintain session states (i.e., view manager elements and their values) rather than application states (i.e., the memory and/or logic utilization of an application at a given instant in time).

Applications 318 may include computer executable instructions, which may be loaded into mass memory and run on operating system 308. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth.

Applications 318 may include view definition logic 320, view manager 322, and/or model 324. Each of these application may be executing on same or different or separate server devices.

View definition logic 320 may provide view definition 312 to a client computer upon request from the client computer for a corresponding page. View definition logic 320 may also provide an initial set of parameters for the view (i.e., view initialization). In various embodiments, server computer 300 may filter the view definition based on characteristics of the requesting client computer. In some embodiments, view definition logic 320 may perform this filter. In other embodiments, however, another application may also perform the filtering.

View manager 322 may determine a result or otherwise perform actions (or interaction logic) in response to commands from a client computer (e.g., from remote data binder 224 and/or view manager proxy 226 of FIG. 2) without involving model 324. In other embodiments, view manager 322 may implement simple model-type application logic internally, without calling into external code or a separate model (e.g., model 324). In yet other embodiments, view manager 322 may provide requests to model 324, which may be on a same server computer as view manager 322 or a separate server computer or other network device.

In various embodiments, view manager 322 may enable synchronize data between server computer 300 and client computer 200 of FIG. 2. In at least one embodiment, view manager 322 may synchronize session states with application manger proxy 226 of FIG. 2. In other embodiments, view manager 322 may push data updates to remote data binder 224 of FIG. 2, which can be employed to update the view provided to a user on client computer 200 of FIG. 2 (e.g., based on the relationships between the view elements and the view manager elements).

Model 324 may include the business logic, application logic, data, or the like. In various embodiments, model 324 may be on a same device as view manager 322 or on a separate, different device.

So, in some embodiments, server computer 300 in conjunction with client computer 200 of FIG. 2 may be enabled to employ various embodiments, combinations of embodiments, processes, or parts of processes, as described herein.

### System Overview

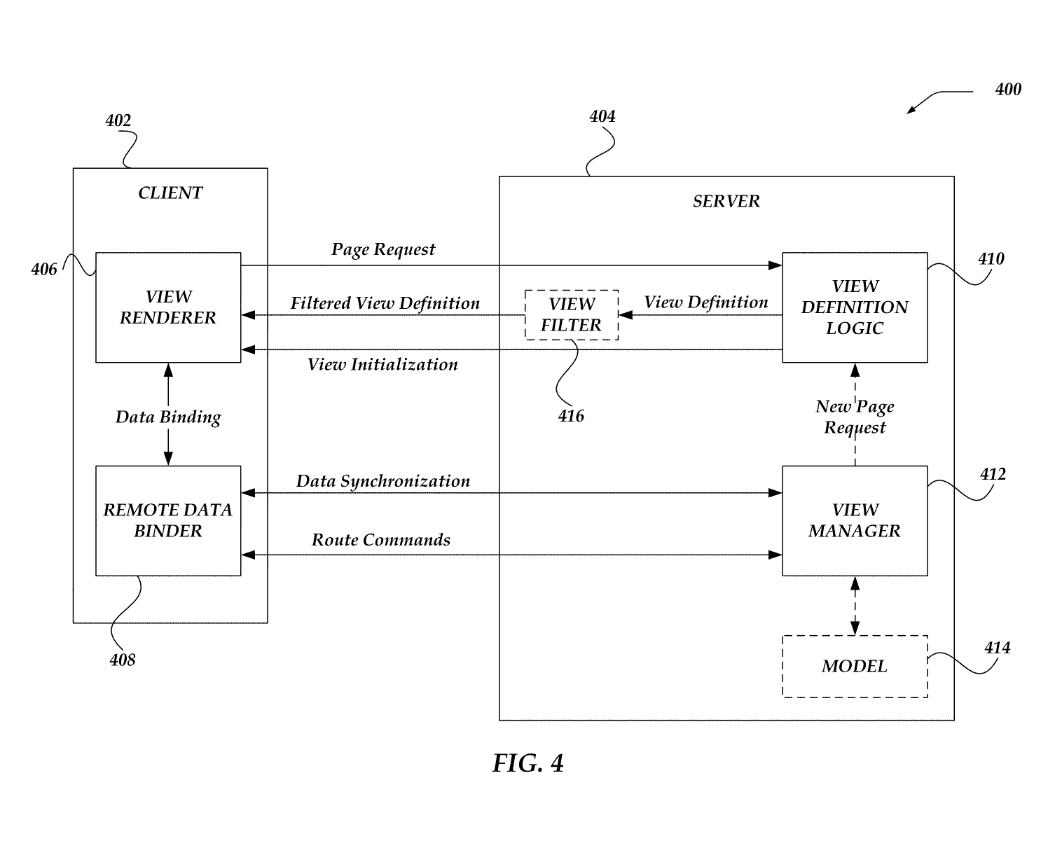

FIG. 4 illustrates an embodiment of a system diagram of a framework to enable a client computer to provide a view of an application that is executing on a server computer. System 400 may be a framework for enabling an application (e.g., a mobile application) to execute on a server computer while providing a view and user interface on a client computer. System 400 may include client 402 and server 404. Client 402 may be an embodiment of client computer 200 of FIG. 2. In some embodiments, client 402 may be software, hardware, or a combination thereof that may be executing on client computer 200 of FIG. 2, and may be referred to as the client-side component of the framework. Client 402 may include view renderer 406 and remote data binder 408.

Server 404 may be an embodiment of server computer 300 of FIG. 3. In some embodiments, server 404 may be software, hardware, or a combination thereof that may be executing on server computer 300 of FIG. 3, and may be referred to as the server-side component of the framework. Server 404 may include view definition logic 410 and view manager 412, and optionally view filter 406 and/or model 414. In some embodiments, server 404 may instantiate a separate virtual machine per application or per user.

In various embodiments, the framework or application development and runtime environment described herein may include view definition logic 410, view manager 412, view renderer 406, and remote data binder 408 (view filter 416 and/or model 414 may be optionally included in the framework). As indicated above, view renderer 406 and remote data binder 408 may be the client-side component of the framework. And view definition logic 410 and view manager 412 (and optionally view filter 416 and/or model 414) may be the server-side component of the framework.

In various embodiments, view renderer 406 may be an embodiment of view renderer 222 of FIG. 2. View renderer 406 may provide a page request to definition logic 410. In some embodiments, the page request may also include characteristics or information regarding client 402. The client characteristics may include, but are not limited to, client computer operating system and version, device type (e.g., smart phone, tablet, web browser, or the like), logical and/or physical screen resolutions, current orientation (e.g., landscape or portrait) and/or supported orientations, or other client computer characteristics or metrics. In some other embodiments, client 402 may provide this characteristic information to server 404 prior to sending a page request, such as when client 402 establishes a session with server 404 (which may occur when the client-side component is initialized, such as when a user of a client computer opens an application that manages/runs the client-side component).

In various embodiments, view definition logic 410 may be an embodiment of view definition logic 320 of FIG. 3. View definition logic 410 may provide a view definition for the requested page to view renderer 406. In various embodiments, the view definition may be provided to the client in one or more transactions between the server and the client. For example, in one transaction the server may provide the view element definitions, and in another transaction the server may provide the relationships between the view elements and view manager elements (i.e., the data binding conditions).

In some embodiments, the view definition may be first provided to view filter 416 prior to being provided to view renderer 406. In some embodiments, view filter 416 may modify or otherwise adjust the view definition based on one or more criteria, conditions, or application state. In other embodiments, view filter 416 may select a version of the view definition from a plurality of different view definition versions based on the one or more criteria. The criteria that may be utilized to filter the view definition may include, but is not limited to, client computer characteristics or metrics, previous information provided by a user, user preferences, time of day or year, or the like. For example, a previous page might ask the user which language they speak, and that preference might be stored and then later used to filter other view definitions when rendering another view (looking up the appropriate localized resources). However, embodiments are not so limited and other criteria may also be employed to filter the view definition.

View filter 416 may enable a tailored view definition to be provided to client 402. View filter 416 may provide the filtered/modified/custom view definition to view renderer 406. In at least one of various embodiments, view filter 416 may be optional and view definition logic 410 may provide the view definition directly to view renderer 406. In some embodiments, the functionality of view filter 416 may be included in view definition logic 410.

View definition logic 410 may also provide a view initialization to view renderer 406. The view initialization may include data and/or commands that can be employed to provide an initial view to a user of client 402.

View renderer 406 may employ the received view definition to provide or otherwise render a view to a user of client 402. As described herein, the view definition may define the view elements to be displayed on the client computer. View renderer 406 can use those view elements to generate/render a view or display to the user. In various embodiments, view renderer 406 may provide appropriate native controls or other user interface elements to represent the view on the client computer. View renderer 406 may provide an initial view based on the view initialization provided by view definition logic 410. In various embodiments, view renderer 406 may be employed to receive inputs via a user interface associated with a rendered view.

In various embodiments, remote data binder 408 may be an embodiment of remote data binder 224 of FIG. 2. Remote data binder 408 may determine and/or manage relationships between view elements and view manager elements based on the view definition. Remote data binder 408 may provide data binding—locally to client 402—between view elements associated with a view (and view renderer 406) and view manager elements associated with view manager 412. Remote data binder 408 may provide complete separation of the view and the view manager, such that view manager 412 can be implemented on server 404 while view renderer 406 is implemented on client 402.

Remote data binder 408 may be enabled to be an intermediary that enables synchronization and/or routing of data, commands, notifications, or the like between view renderer 406 and view manager 412. In various embodiments, data and/or commands input through the user interface of the view may be passed from view renderer 406 to remote data binder 408. In some embodiments, remote data binder 408 may obtain the user input directly from the user interface. Remote data binder 408 may perform data binding on the received/input data/commands such the data/commands are linked from the view elements (from which they were input) to corresponding view manager elements (based on the relationships defined in the view definition). Remote data binder 408 may then synchronize and/or route the data/commands to view manager 412 via the bound view manager elements.

View manager 412 may determine a result or otherwise perform some actions based on the received data/commands associated with the bound view manager elements. View manager 412 may provide/synchronize resulting data (or commands) back to remote data binder 408 via at least one other view manager element. In various embodiments, view manager 412 may provide commands back to client 402, via remote data binder 408. For example, view manager 512 may instruct the client to display an “alert” (e.g., a platform-specific prompt displaying optionally a title/caption, a message, and some set of buttons that the user can choose from to specify a response). In another example, view manager 412 may provide a command to instruct the client to render a certain view.

In any event, remote data binder 408 may perform data binding on the resulting data such that the data are linked from the at least one other view manager element (from which the result corresponds) to corresponding view elements (based on the relationships defined in the view definition). View renderer 406 can then update the view based on the results data associated with the bound view elements. In various embodiments, remote data binder 408 may support one-way and/or two-way synchronization/routing, as described herein (some relationships between view elements and view manager elements may be one-way, while other relationships may be two-way).

In various embodiments, view manager 412 may be an embodiment of view manager 322 of FIG. 3. View manager 412 may contain and manage the underlying data that drives the view provided by view renderer 406. View manager 412 may implement the logic/code employed to respond to data and/or commands (e.g., as provided by a user through the graphical user interface associated with the view) via view manager elements.

In some embodiments, view manager 412 may interact with model 414, where model 414 is an external component to view manager 412. In various embodiments, model 414 may be an embodiment of model 324 of FIG. 3 and may include the business logic, application logic, data, or the like. In at least one of various embodiments, model 414 may be implemented on a same or a separate server computer as view manager 412. In other embodiments, view manager 412 may be implemented without calling model 414. In yet other embodiments, at least a portion of the functionality of model 414 may be incorporated in view manager 412.

For example, in response to certain commands, view manager 412 may implement interaction logic that may not involve model 414. In other embodiments, view manager 412 may implement model-type application logic internally, without calling into any external code or separate model component (e.g., model 414). In yet other embodiments, view manager 412 may call model 414 to perform additional actions (e.g., accessing a database, performing additional logic, or the like).

Model 414, if employed by view manager 412, may provide a result back to view manager 412. View manager 412 may provide/synchronize results of its actions (or results provided by model 414) to remote data binder 408. As described herein, remote data binder 408 may employ the relationships defined by the view definition to update view renderer 406 based on the results provided by view manager 412. In various embodiments, the results from view manager 412 may be for a new page (e.g., if a user clicks on a button to go to a different screen or view). In some embodiments, server 404 may return the new page by employing view manager 412 to provide a new page request to view definition logic 410. View definition logic 410 may then provide a new view definition to view renderer 406 for the new page request. In other embodiments, view manager 412 may provide an instruction to client 402 prompting it to request the new page. View renderer 406 may then request the new page from view definition logic 410, and view definition logic 410 may provide the new view definition to view renderer 406.

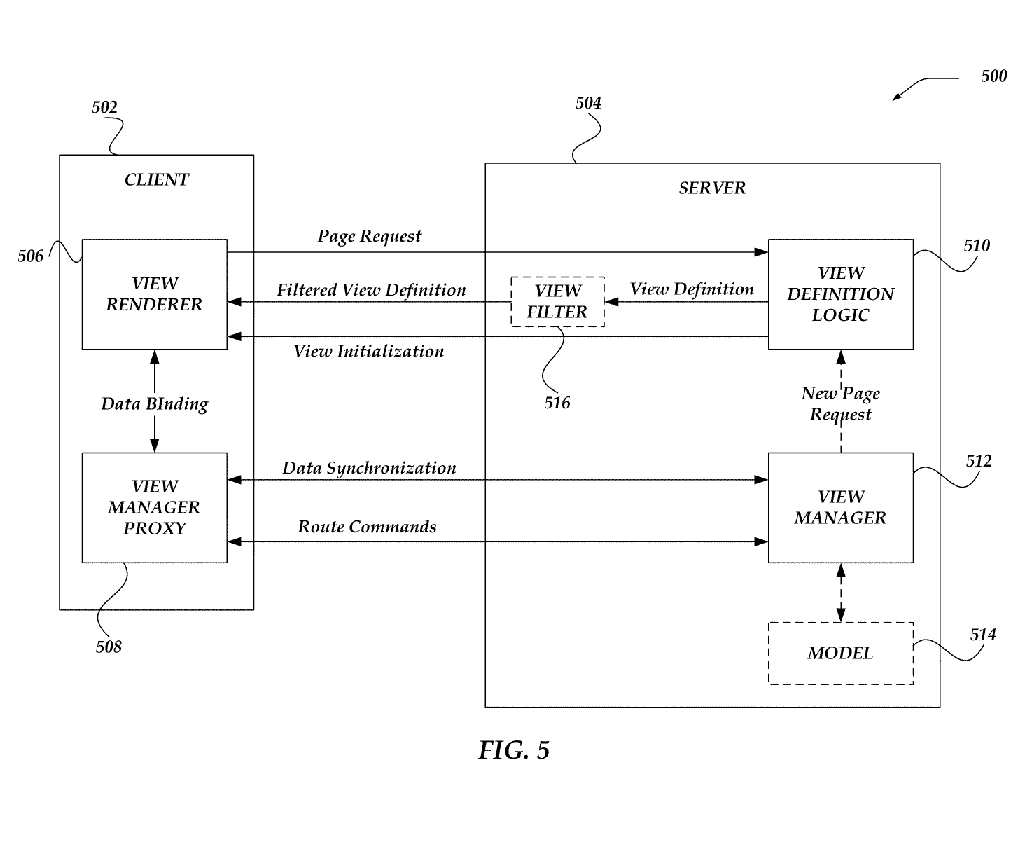

FIG. 5 illustrates an alternative embodiment of a system diagram of a framework to enable a client computer to provide a view of an application that is executing on a server computer. System 500 may employ many of the same embodiments as described in conjunction with FIG. 4 and elsewhere herein. For example, client 502 and server 504 may be embodiments of client 402 and server 404 of FIG. 4, respectively.

Client 502 may include view renderer 506 and view manager proxy 508. View renderer 506 may be an embodiment of view renderer 406 of FIG. 4. Server 504 may include view definition logic 510 and view manager 512 (and optionally view filter 516 and/or model 514). View definition logic 510, view manager 512, view filter 516, and model 514 may be embodiments, of view definition logic 410, view manager 412, view filter 416, and model 414 of FIG. 4, respectively.

View manager proxy 508 may employ embodiments of remote data binder 408 of FIG. 4, but may also provide additional functionality. In various embodiments, view manager proxy 508 may maintain a state of view manager 512, and the view manager elements, on client 502. View manager proxy 508 may synchronize/route data and/or commands with view manager 512 on server 504 as-needed. So, view manager proxy 508 may synchronize its local state of the view manager elements with view manager 512 and the server session state of the view manager elements.

In various embodiments, at least a portion of the data binding condition included in the view definition can include information as to when specific data changes (and/or commands/notifications) should be sent to the server and view manager 512. These conditions may trigger and/or otherwise indicate on what basis, and in response to what user actions, timeouts, or other events, should data be synchronized between the client and the server. So, in some embodiment, at least a portion of the relationships defined by the view definition may include at least one synchronization condition for triggering client 502 to provide data and/or commands to server 504. If a synchronization condition is satisfied, client 502 to provide the data and/or commands to server 504.

In various embodiments, the synchronization condition may be explicit or implicit. For example, client 502 may implicitly send any data that has not been synchronized to the server when it sends a command. In this way, the default/implicit behavior is that controls do not synchronize their data, except upon a command. In other embodiments, client 502 the synchronization condition may provide an explicit directive that specifies on what basis data and/or commands should synchronize.

In some embodiments, view manager proxy 508 may automatically determine at least one condition on what data/commands need to be synchronized and on what basis based on the view definition and the structure of view manager 512, even if the view definition does not include such conditions. In some embodiments, these automatically determined conditions may be selected from a set of predetermined synchronization conditions. Synchronizing data (or routing commands/notifications) as-needed can reduce the amount of data sent back and forth between the client and the server. In various embodiments, “as needed” may be based on an activation of a command, periodically (e.g., a predetermined time intervals), meeting a buffer size limit/threshold, or the like.

For example, assume a customer database search application. Assume the graphical user interface of the view includes a “search” button and an edit control (i.e., a view element) where a user can enter a customer name. View manager proxy 508 can data bind the data entered into the edit command to a view manager element (e.g., “CustomerName”). View manager proxy 508 can also maintain and update a copy of the CustomerName each time a user enters a character into the edit command, without sending each newly entered character to view manager 512 (because the CustomerName element may include a condition to not send the current value of CustomerName or a condition to send once the search button is activated). The view definition for the search button may include a condition such that view manager proxy 508 can instruct view renderer 506 to enable and disable the search button in near real-time as the user enters/deletes characters, without having to send each individual change to view manager 512 on server 504. When the user clicks the search button, view manager proxy 508 can send the current value of CustomerName, and the search command, to view manager 512 (because the search command may include a synchronization condition to send the current value of CustomerName). This example can be contrasted with the embodiments of FIG. 4, where remote data binder 408 may automatically synchronize the CustomerName with view manager 412 every time a user enters or deletes a character.

It should be recognized that embodiments are not so limited and view manager proxy 508 may maintain conditions for providing data/commands to view manager 512 may be based on other “as needed” criteria, such as, but not limited to, an activation of a command, periodically (e.g., a predetermined time intervals), reaching a buffer size limit, or the like, or a combination thereof.

In some embodiments, view manager proxy 508 may locally bind at least one different view element based on a view manager element bound to the user input, where the different view element is not the same view element associated with the user input. The view may be updated based on the at least one different view element. In this way, the client can update one view element based on an input to another view element without having to synchronize or provide any data/commands to the server. For example, a button (i.e., the different view element) may be enabled/disabled based on whether there is anything in a search edit field (i.e., view element associated with the input). In various embodiments, the different view element may be updated based on a condition (similar to the synchronization conditions described herein) being satisfied.

In various embodiments, the module state, of either view manager proxy 508 or view manager 512, may, or may not, be maintained either on the client or on the server. So, in some embodiments, a state of the session between the server and the client may be maintain. In this way, the server may maintain the values (data and/or commands) of view manager elements regardless of the view manager. So, the view manager can be modified without altering the session between the client and the server. This server statelessness can enable a developer to modify view manager 512 while a user is employing client 502. The user may observe the changes after the next user input that is data bound and provided to view manager 512 and results returned to the client.

Although described herein as employing sessions and session states of the view manager, embodiments are not so limited. In some embodiments, there may be a dedicated session between the server and the client. In other embodiments, some other relationship between the server and the client that can facilitate communication between the two may also be employed. So the term session state, as used herein, may also refer to a server state of the view manager maintained by the server computer—as compared to a client state (or local state) of the view manager maintained by the client computer.

### General Operation

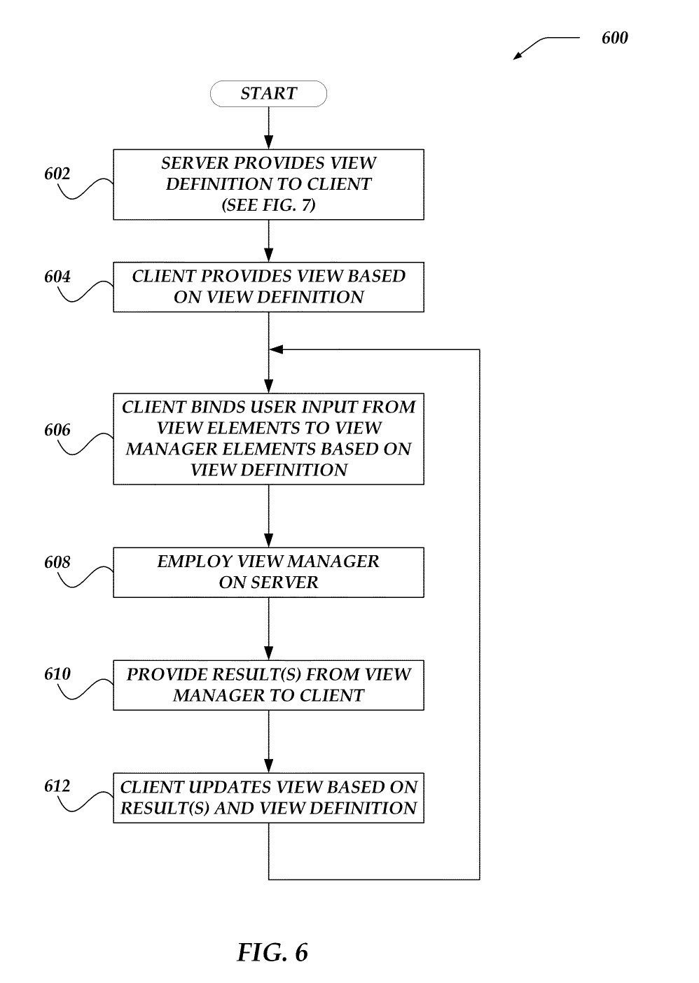

The operation of certain aspects of the invention will now be described with respect to FIGS. 6-9. In at least one of various embodiments, processes 600, 700, 800, or 900 of FIGS. 6, 7, 8, and 9, respectively, may be implemented by and/or executed on a combination of computers, such as client computer 200 of FIG. 2 and server computer 300 of FIG. 3. Additionally, various embodiments described herein can be implemented in a system such as system 100 of FIG. 1.

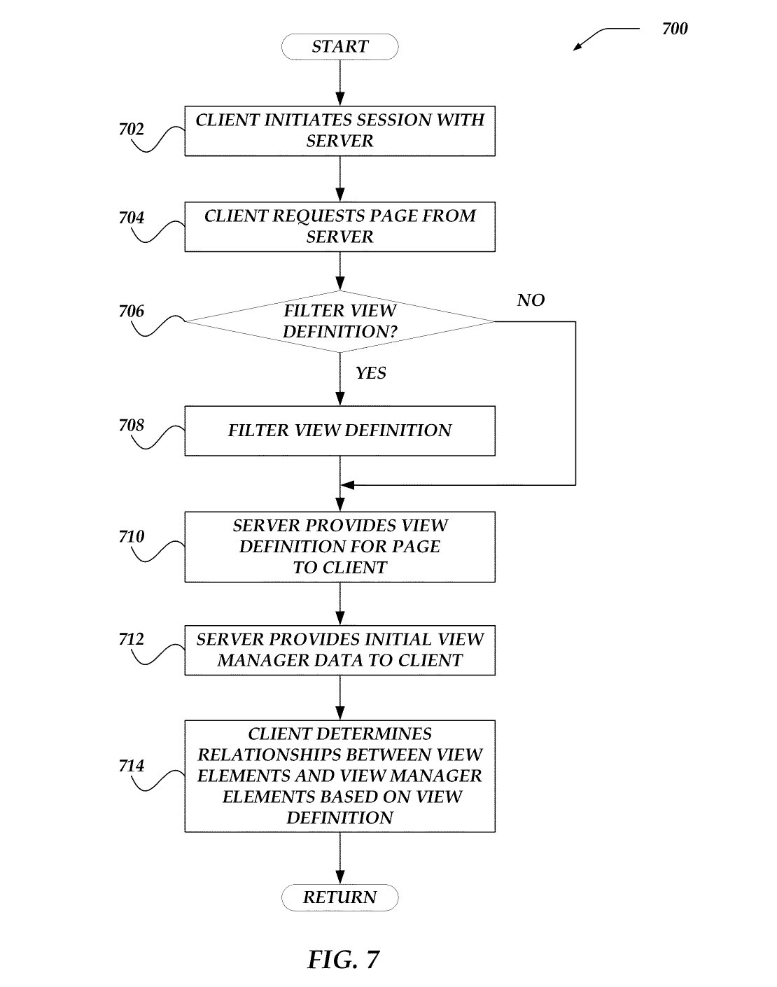

FIG. 6 illustrates a logical flow diagram generally showing one embodiment of an overview process for enable a client computer to provide a view of an application that is executing on a server computer. Process 600 may being, after a start block, at block 602, which is described in more detail below in conjunction with FIG. 7. Briefly, however, a server (e.g., server computer 300 of FIG. 3 and/or view definition logic 406 of FIG. 4) may provide a view definition to a client (e.g., client computer 200 of FIG. 2 and/or view renderer 406 of FIG. 4). As described herein, the view definition may define each view element to be rendered in a view on the client. The view definition may also include instructions for or define relationships between the view elements and view manager elements of a view manager that is executing on the server. In various embodiments, the view definition may be provided to the client in one or more transactions between server and the client. For example, in one transaction the server may provide the view element definitions, and in another transaction the server may provide the relationships between the view elements and view manager elements. In some embodiments, the client may request the relationships between the view elements and view manager elements separate, or as needed, from the server.

Process 600 may proceed to block 604, where the client may provide a view to a user based on the view definition. The view may include the one or more view elements, which may include text, text boxes, pull down lists, icons, command buttons, edit controls, radio buttons, other commands/controls, or the like. These view elements may be rendered/displayed by a graphical user interface (e.g., using view renderer 406 of FIG. 4) for observation and/or interaction by a user of the client.

Process 600 may proceed to block 606. Blocks 606, 608, 610, and 610 may, where the client may locally bind user input from the view elements to view manager elements based on the view definition. In various embodiments, the user input may be data and/or commands. As described herein, the view definition may define relationships between the view elements and the view manager elements. The client may employ these relationships to locally bind the input associated with view elements to view manager elements. The client may perform data binding, as described herein (e.g., by remote data binder 408 of FIG. 4 and/or view manager proxy 508 of FIG. 5), to provide the input from the view on the client to the view manager on the server.

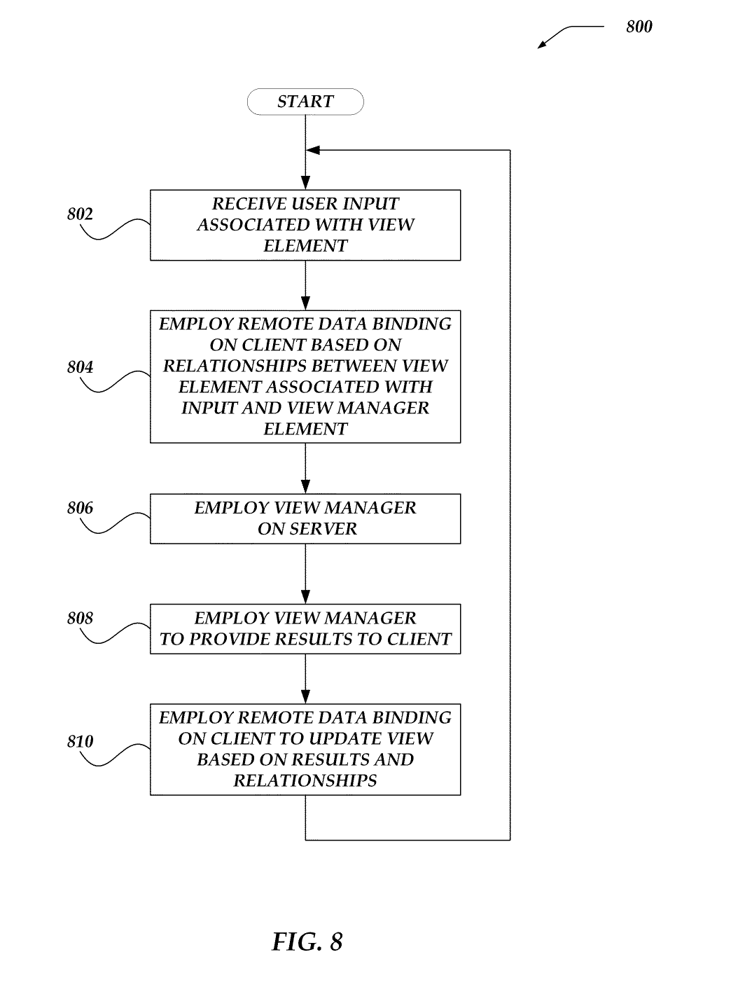

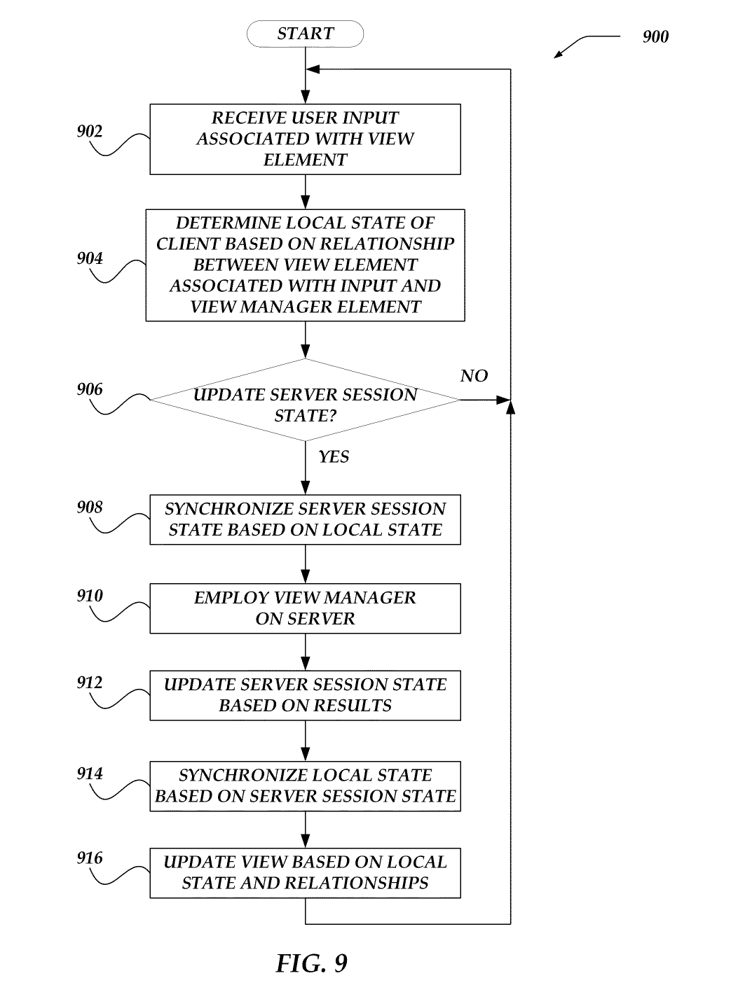

In some embodiments, each user input (data, command, or notification) may be data bound—local to the client—to view manager elements and automatically provided from the client to the view manager on the server as the user enters each input, which is described in more detail in conjunction with FIG. 8. In other embodiments, each user input (data, command, or notification) may be data bound to view manager elements and the client may maintain/store a local state of the view manager elements—the client may later provide and/or synchronize the current local state of view manager elements to the view manager on the server based on a condition in the view definition that defines a trigger for providing the bound data to the server, which is described in more detail below in conjunction with FIG. 9.

In any event, process 608 may continue at block 608, where the view manager (e.g., view manager 412 of FIG. 4) executing on the server may be employed to determine a result based on the user input bound to the view manager elements. In some embodiments, a command, data update, or other notification may trigger and/or instruct the view manager to determine the result.

In various embodiments, the view manager may perform some logic and/or action on the received data/commands to determine a result. In other embodiments, the view manager may call a model (e.g., model 414 of FIG. 4) or other component or server to perform logic/actions to determine a result. For example, the result may be a response to a query, affirmative verification of an authentication scheme, or the like. In some embodiments, the result may be assigned or correspond to one or more view manager elements.

Process 600 may proceed next to block 610, where the results may be provided to the client from the view manager. In various embodiments, the server (e.g., the view manager) may send the view manager elements that correspond to the result to the client (e.g., a remote data binder or view manager proxy). In some embodiments, the view manager may update the server session state of its view manager elements based on the result. The server may then provide/synchronize the server session state with the local state of the view manager elements on the client so that the client now has the results.

Process 600 may continue next at block 612, where the client may update the view based on the results and the view definition. In various embodiments, the client may bind the result associated with the view manager elements from block 610 to at least one view element based on the relationships defined in the view definition. The client may then update the view based on the bound view elements.

Further embodiments of blocks 606, 608, 610, and 612 are described herein in conjunction with FIGS. 8 and 9. After block 612, process 600 may loop to block 606, where additional user input may be provided to the client and bound to view manager elements based on the view definition.

FIG. 7 illustrates a logical flow diagram generally showing one embodiment of a process for initializing a client session with a server and providing a view definition to the client. Process 700 may being, after a start block, at block 702, where a client initiates a session with a server. In various embodiments, this initiation may occur when a client-side component (e.g., client 402 of FIG. 2) is executed on the client (e.g., client computer 200 of FIG. 2). In some embodiments, the client may provide characteristics of the client to the server. These characteristics may include, but are not limited to, client operating system and version, device type (e.g., smart phone, tablet, web browser, or the like), logical and/or physical screen resolutions, current orientation (e.g., landscape or portrait) and/or supported orientations, or other client characteristics or metrics.

Process 700 may proceed to block 704, where the client may request a page from the server. This page request may be for a particular screen/display of an application that may perform some unit of functionality.

Process 700 may continue a decision block 706, where a determination may be made whether a view definition for the requested page is filtered. In some embodiments, this determination may be based on the characteristics provided by the client, such as if the client may requires a tailored version of the view definition to properly render a view. In other embodiments, this determination may be predetermined, such as by an administrator, so that filtering may be automatically performed or that no filter is performed. If the view definition is filtered, process 700 may proceed to block 708; otherwise, process 700 may flow to block 710.

At block 708, the view definition associated with the requested page may be filtered. In various embodiments, the server (e.g., view filter 416 of FIG. 4) may filter a view definition by modifying and/or adjusting the view definition based on one or more criteria/preferences. As described herein, the filtering criteria may include, but is not limited to, client computer characteristics or metrics, previous information provided by a user, user preferences, time of day or year, or the like. For example, a location of a button may be modified based on a screen size of the client. In other embodiments, view definition filtering may include a selection of a view definition version that is suitable for the client. For example, the server may maintain a plurality of view definitions for a given page, and a one of the plurality of view definitions may be selected based on the client characteristics or other criteria.

Process 700 may proceed to block 710, where the server may provide the view definition for the requested page to the client. If the view definition is filtered at block 708 then the filtered/modified view definition may be provided to the client. As described herein, the view definition may define a plurality of view elements (some of which may be displayable by a graphical user interface to a user of the client, others may correspond to physical user interfaces of the client). The view definition may define relationships between at least one of the plurality of view elements and at least one view manager element, which may be employed by the client to bind user input associated with the view elements to view manager elements. Similarly, the view definition may also include conditions for triggering the client to provide/synchronize view manager element data/commands from the client to the server.

In any event, process 700 may continue at block 712, where the server may provide initial view manager data to the client. This view manager data may be data that drives the view, when employed by the client (e.g., by a view renderer), but originates at the server and may be maintained by the view manager. In some embodiments, this view initialization may be default data associated with the view. In at least one of various embodiments, the view initialization may be default or initial values of one or more view elements.

Process 700 may proceed next to block 714, where the client may determine relationships between view elements and view manager elements based on the view definition. In various embodiments, the client may parse and/or otherwise process the view definition received from the server to identify and/or determine these relationships. In some embodiments, the client may store these relationships until a new view definition is provided. The relationships between view elements and view manager elements may define the links between elements such that the client can employ data binding on user input (including both data and commands), as described herein.

After block 714, process 700 may terminate and/or return to a calling process.

FIG. 8 illustrates a logical flow diagram generally showing one embodiment of a process for enabling remote data binding between view elements on the client and view manager elements on the server. Process 800 may begin, after a start block, at block 802, where user input associated with a view element may be received. For example, the user may click on a button (i.e., a view element), the user may enter text into an edit control (i.e., another view element), or the like. It should be recognized that not all view elements may be enabled to accept user input. Examples of such non-input view elements may include a label or plain text, a background, or the like.

Process 800 may proceed to block 804, where remote data binding may be employed on the client based on relationships between the view element associated with the input and one or more view manager elements. As described herein (e.g., at blocks 710 and/or 714 of FIG. 7), the view definition provided to the client may define the relationships between the view elements and the view manager elements. In various embodiments, the client (e.g., remote data binder 408 of FIG. 4) may assign a value from a view element to a view manager element based on at least one defined relationship.

Process 800 may continue at block 806, where a view manager executing on the server may be employed. Once view manger elements are assigned/bound (e.g., at block 804), the client may automatically provide the bound view manager element values (which may include data, commands, notifications, or the like) to the server. In various embodiment, the view manager (e.g., view manager 412 of FIG. 4) may perform some actions based on the received data/commands associated with the bound view manager elements. In some embodiments, the view manager may employ other components (e.g., model 414 of FIG. 4) to perform actions. Based on the actions performed by the view manager (or other component) a result may be determined. This result may be determined based on the data and/or commands provided by the client. In various embodiments, the result may be assigned/associated with one or more view manager elements.

Process 800 may proceed next to block 808, where the view manager may be employed to provide results to the client. In various embodiments, the view manager may provide the client with the view manager elements and their values that correspond to the results. It should be recognized that the view manager elements associated with the results and provided back to the client may be the same or different view manager elements that were provided to the server with the user input.

Process 800 may continue next at block 810, where remote data binding may be employed on the client to update the view based on the results and the relationships defined by the view definition. In various embodiments, the client (e.g., remote data binder 408 of FIG. 4) may assign/associated the results values of the view manager elements (as received from the server) to view elements based on the relationships. The client (e.g., view renderer 406 of FIG. 4) may then update the view to include the results based on the new view element values. It should be recognized that the view elements employed to update the view with the results may be the same or different view elements that were associated with the user input.

After block 810, process 800 may loop to block 802 to wait for additional user inputs.

FIG. 9 illustrates a logical flow diagram generally showing one embodiment of a process for enabling a view manager proxy to provide controlled synchronization of remote data binding between view elements on the client and view manager elements on the server. Process 900 may begin, after a start block, at block 902, where user input associated with a view element may be received. In various embodiments, block 902 may employ embodiments of block 802 of FIG. 8.

Process 900 may proceed to block 904, where a local state of the client may be determined based on the relationships between the view elements associated with the input and one or more view manager elements. In various embodiments, block 904 may employ embodiments of block 804 of FIG. 4 to perform data binding between view elements and view manager elements based on the relationships defined by the view definition. However, the client (e.g., view manager proxy 508 of FIG. 5) may maintain/store the current local state of the view manager elements without automatically providing them to the server (as described in FIG. 8).

Process 900 may continue at decision block 906, where a determination may be made whether a server session state may be updated. As described herein, the server may maintain a sever state of the view manager, while the client may maintain a local state or client state of the view manager. In various embodiments, this determination may be based on conditions that correspond to the relationship between the view element and the view manager element associated with the user input. These conditions may indicate when to provide the current local state of the view manger elements to the server. In some embodiments, one or more conditions may be satisfied before the client provides the current local state to the server.

For example, if the input is through an edit control, the client may determine its local state to be the value of the edit control. Each time a user enters a character, the local state may be updated at block 904. However, the relationship between the edit control and the underlying view manager element may include a condition such that the client does not update the server until a command button (e.g., a search button) is clicked by the user. In some embodiments, the relationship between the command button and the underlying view manager element may include the condition for updating the server session state. However, embodiments are not so limited and other conditions for triggering the client to update the server session state may also be employed.

If the server session state may be updated, then process 900 may flow to block 908; otherwise, process 900 may loop to block 902 to wait for addition user input.

At block 908, the server session state of the view manager elements may be synchronized based on the current local state of the view manager elements. In some embodiments, synchronizing the server session state may be referred to as updating the server session state of the view manager that is executing on the server.

In various embodiments, the server may maintain the server session state, where the client maintains a session id and provides updates to the server. In various other embodiments, the client could store all state information and send the complete state (all view manager data) every time a command needs to be processed.

In some embodiments, the client may send its current local state to the server, and the server may update its session state based on the received local state. In other embodiments, the client may send previously unsent portions of the current local state the server. For example, using the search example above, if the user enters “bob” into the edit control and presses the search button, then the local state of “bob” and search command may be provided to the server. If the user next adds “jones” to the edit control and presses the search button, then the current local state may be “bob jones” and search command. In this case, the client may send an append command/notification, “jones,” and the search command to the server. In this way, the amount of data transmitted between the client and the server may be reduced. In some embodiments, depending on the local state and/or changes to the local state the entire local state may be provided to the server for synchronization, and not just the delta between a previous synchronization and the current local state.

Process 900 may proceed to block 910, where a view manager on the server may be employed based on the updated server session state. In various embodiments, block 910 may employ embodiments of block 806 of FIG. 8 to employ the view manager (e.g., view manager 512 of FIG. 5) to determine one or more results.

Process 900 may continue at block 912, where the server session state may be updated based on the results determined at block 910. In various embodiments, view manager elements associated with the results may be updated in the server session state of the view manager.

Process 900 may proceed next to block 914, where the local state of the view manager elements on the client may be synchronized based on the updated server session state. In various embodiments, the server may provide the updated session state (i.e., the view manger elements maintained by the server) to the client. In some embodiments, the server may provide those view manager elements that were updated with the results (e.g., the delta). In other embodiments, the server may provide the entire session state to the client.

Process 900 may continue next at block 916, where the view may be updated based on the local state and the relationships. In various embodiments, remote data binding may be employed on the client to update the view based on the updated current local state (i.e., the results) and the relationships defined by the view definition. In various embodiments, the client (e.g., view manager proxy 508 of FIG. 5) may assign/associated the results values of the view manager elements (as received from the server) to view elements based on the relationships. The client (e.g., view renderer 506 of FIG. 5) may then update the view to include the results based on the new view element values. It should be recognized that the view elements employed to update the view with the results may be the same or different view elements that were associated with the user input.

After block 916, process 900 may loop to block 902 to wait for additional user inputs.

It should be understood that the embodiments described in the various flowcharts may be executed in parallel, in series, or a combination thereof, unless the context clearly dictates otherwise. Accordingly, one or more blocks or combinations of blocks in the various flowcharts may be performed concurrently with other blocks or combinations of blocks. Additionally, one or more blocks or combinations of blocks may be performed in a sequence that varies from the sequence illustrated in the flowcharts.

Further, the embodiments described herein and shown in the various flowcharts may be implemented as entirely hardware embodiments (e.g., special-purpose hardware), entirely software embodiments (e.g., processor-readable instructions), or a combination thereof. In some embodiments, software embodiments can include multiple processes or threads, launched statically or dynamically as needed, or the like.

The embodiments described herein and shown in the various flowcharts may be implemented by computer instructions (or processor-readable instructions). These computer instructions may be provided to one or more processors to produce a machine, such that execution of the instructions on the processor causes a series of operational steps to be performed to create a means for implementing the embodiments described herein and/or shown in the flowcharts. In some embodiments, these computer instructions may be stored on machine-readable storage media, such as processor-readable non-transitory storage media.

### Use Case Illustrations

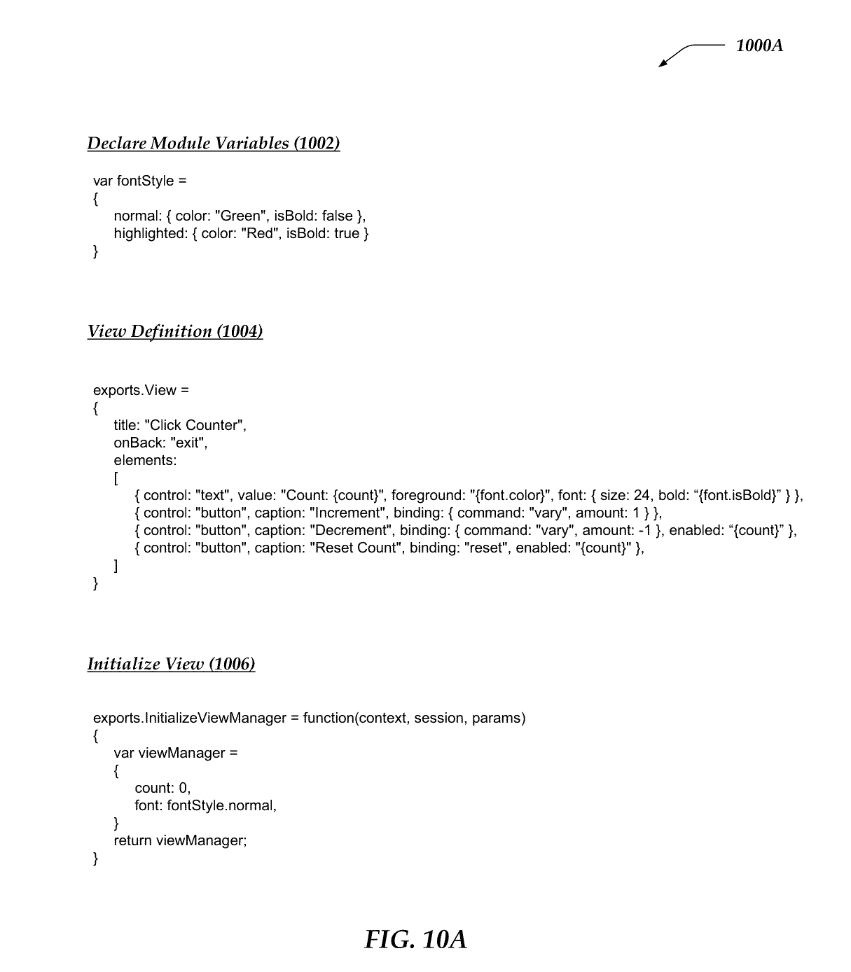

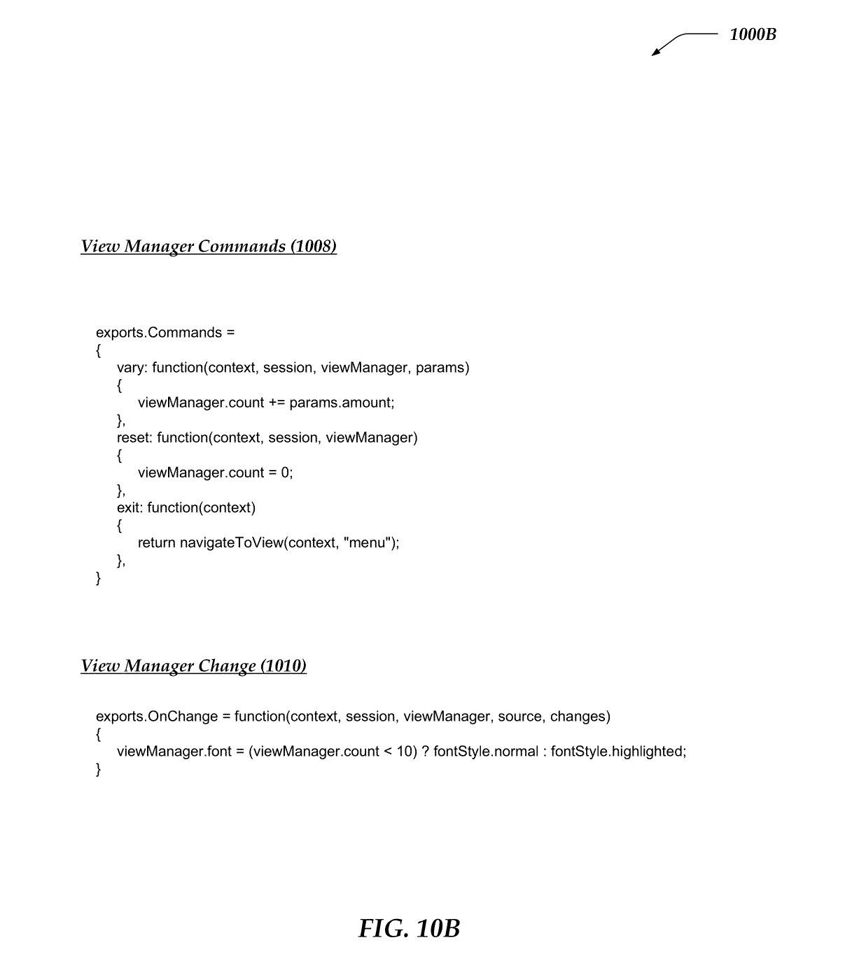

FIGS. 10A-10B show a use case example embodiment of code that may be employed to provide remote data binding. Examples 1000A and 1000B may include various examples of code that can illustrate embodiments described herein. In this example, the application may be for a counter application. The application may display a count, with buttons to increment, decrement, and reset the count. The decrement and reset buttons may be enabled if the count is greater than zero. The count value may be displayed in green with a normal font weight unless the count is greater than or equal to 10, in which case the count may be displayed in red and bold. Again, this description is an example application and other applications may employ embodiments of the framework described herein.

Example 1002 may declare some module variables. When a client (e.g., client 402 of FIG. 4) requests a page, the server (e.g., server 404) may provide the view definition (example 1004) to the client. In some embodiments, example 1004 may be filtered to enable the client to render a view supported by the client computer. The server may then provide initial view manager data (example 1006) for the page to the client. With the view definition and the initial view data, the client may then render the view and begin allowing the user to interact with it.

Various user interactions can trigger view manager commands. In this example, the user clicking any of the button may trigger a command, as will the user activating the platform-specific “back” navigation. The view manager commands may be packaged together and exposed via example 1008.

When view manager data is changed by the client, the server may be notified via example 1010, allowing the page module to take action based on the change, before any commands are executed. The “source” parameter may contain the value “view” in this case because the view was the source of the change.

When view manager data is changed by the execution of a page module command, example 1010 may be called, but in this case with a “source” parameter value of “command” because a command was the source of the change. It should be noted that the command could apply its own post processing, but this call may be provided as a convenience to all centralized handling of view manager data changes in one place. For example, in the counter example, the font may be set based on the count without having to do this from each command that might have modified the count.

The above specification, examples, and data provide a complete description of the manufacture and use of the composition of the invention. Since many embodiments of the invention can be made without departing from the spirit and scope of the invention, the invention resides in the claims hereinafter appended.

1. A method for providing a computer application for a client computer, comprising:
employing a server computer to provide a view definition to the client computer, wherein the view definition defines a view that includes a plurality of view elements to be employed on the client computer and the view definition defines at least one relationship between the plurality of view elements and a plurality of view manager elements of a view manager executing on the server computer;
rendering the view on the client computer based at least on the view definition;
employing the client computer to locally bind user input associated with at least one of the plurality of view elements to at least one of the plurality of view manager elements based on the at least one defined relationship, wherein the at least one defined relationship is employed to automatically update the at least one view manager element executing on the server computer based on the user input with the at least one view element employed on the client computer;
employing the view manager on the server computer to determine a result based on the at least one view manager element; and
employing the client computer to locally bind at least one different view element based on the at least one view manager element bound to the user input, wherein the client computer locally updates the at least one different view element based on a new user input and locally updates the view on the client computer based on the at least one updated different view element.

2. (canceled)

3. The method of claim 1, further comprising:
determining a version of the view definition from a plurality of view definitions based on at least one of characteristics of the client computer, user preferences, or previously provided data; and
providing the determined view definition version to the client computer.

4. (canceled)

5. The method of claim 1, further comprising:
modifying the view definition based on at least one of characteristics of the client computer, user preferences, or previously provided data; and
providing the modified view definition to the client computer.

6. The method of claim 1, wherein employing the client computer to locally bind the user input further comprises:
maintaining a local state of the view manager on the client computer based on the at least one view manager element, wherein the view definition includes conditions for triggering synchronization of the local state with a server state of the view manager on the server computer; and
in response to a synchronization condition being satisfied, synchronizing the local state with the server state of the view manager on the server computer.

7. The method of claim 1, wherein employing the client computer to locally bind the user input further comprises:
employing the client computer to locally bind the at least one different view element based on the at least one view manager element bound to the user input; and
updating the view on the client computer based on the at least one different view element.

8. The method of claim 1, wherein employing the client computer to locally bind the user input further comprises:
locally binding at least one of data, commands, or notifications from the at least one view element to the at least view manager element.

9. The method of claim 1, wherein the view definition includes at least one condition for triggering the client computer to provide the user input bound to the at least one view manager element from the client computer to the server computer.

10. A system for providing a computer application for a client computer, comprising:
a server computer comprising:
a memory for storing at least instructions; and
a processor that executes the instructions to enable actions, including:
providing a view definition to the client computer, wherein the view definition defines a view that includes a plurality of view elements to be employed on the client computer and the view definition defines at least one relationship between the plurality of view elements and a plurality of view manager elements of a view manager executing on the server computer; and
employing the view manager to determine a result based on at least one of the plurality of view manager elements; and
the client computer
a memory for storing at least other instructions; and
a processor that executes the other instructions to enable actions, including:
rendering the view on the client computer based at least on the view definition; and
locally binding user input associated with at least one of the plurality of view elements to the at least one view manager element based on the at least one defined relationships, wherein the at least one defined relationship is employed to automatically update the at least one view manager element executing on the client computer based on the user input with the at least one view element employed on the client computer; and
locally binding at least one different view element to the at least one view manager element bound to the user input, wherein the at least one different view element is locally updated based on a new user input and the view on the client computer is also locally updated based on the at least one updated different view element.

11. (canceled)

12. The system of claim 10, wherein the processor of the server computer that executes the instructions enables further actions, comprising:
determining a version of the view definition from a plurality of view definitions based on at least one of characteristics of the client computer, user preferences, or previously provided data; and
providing the determined view definition version to the client computer.

13. (canceled)

14. The system of claim 10, wherein the processor of the server computer that executes the instructions enables further actions, comprising:
modifying the view definition based on at least one of characteristics of the client computer, user preferences, or previously provided data; and
providing the modified view definition to the client computer.

15. The system of claim 10, wherein locally binding the user input further comprises:
maintaining a local state of the view manager on the client computer based on the at least one view manager element, wherein the view definition includes conditions for triggering synchronization of the local state with a server state of the view manager on the server computer; and
in response to a synchronization condition being satisfied, synchronizing the local state with the server state of the view manager on the server computer.

16. The system of claim 10, wherein locally binding the user input further comprises:
locally binding at least one of data, commands, or notifications from the at least one view element to the at least view manager element.

17. The system of claim 10, wherein the view definition includes at least one condition for triggering the client computer to provide the user input bound to the at least one view manager element from the client computer to the server computer.

18. A system for providing a computer application for a client computer, comprising:
view definition logic executing on a processor of a server computer that provides a view definition to the client computer, wherein the view definition defines a view that includes a plurality of view elements to be employed on the client computer and the view definition defines at least one relationship between the plurality of view elements and a plurality of view manager elements;
view manager logic executing on the processor of the server computer that determines a result based on at least one of the plurality of view manager elements;
view renderer logic executing on a processor of the client computer that renders the view on the client computer based at least on the view definition;
binder logic executing on the processor of the client computer that locally binds user input associated with at least one of the plurality of view elements to the at least one view manager element based on the at least one defined, wherein the at least one defined relationship is employed to automatically update the at least one view manager element executing on the server computer based on the user input with the at least one view element employed on the client computer; and
logic executing on the processor of the client computer locally binds at least one different view element based on the at least one view manager element bound to the user input, wherein the view client computer locally updates the at least one different view element based on a new user input and locally updates the view on the client computer based on the at least one updated different view element.

19. The system of claim 18, wherein the view definition logic determines a version of the view definition from a plurality of view definitions based on at least one of characteristics of the client computer, user preferences, or previously provided data, and provides the determined view definition version to the client computer.

20. (canceled)

21. The system of claim 18, wherein the binder logic locally binds at least one different view element based on the at least one view manager element bound to the user input, and wherein the view renderer component updates the view on the client computer based on the at least one different view element.

22. The system of claim 18, wherein the binder logic maintains a local state of the view manager component on the client computer based on the at least one view manager element, wherein the view definition includes conditions for triggering synchronization of the local state with a server state of the view manager component on the server computer, and in response to a synchronization component being satisfied, synchronizes the local state with the server state of the view manager component on the server computer.

23. The system of claim 18, wherein the binder logic locally binds at least one of data, commands, or notifications from the at least one view element to the at least view manager element.

24. (canceled)

25. A network computer for employing a computer application, comprising:
a memory for storing at least instructions; and
a processor that executes the instructions to enable actions, including:
receiving a view definition from a server computer, wherein the view definition defines a view that includes a plurality of view elements to be employed on the client computer and the view definition defines at least one relationship between the plurality of view elements and a plurality of view manager elements of a view manager executing on the server computer;
rendering the view on the network computer based at least on the view definition;
locally binding user input associated with at least one of the plurality of view elements to at least one of the plurality of view manager elements based on the at least one defined relationships, wherein the at least one defined relationship is employed to automatically update the at least one view manager element executing on the server computer based on the user input with the at least one view element employed on the client computer; and
receiving a result based on the at least one view manager element from the view manager on the server computer; and
locally binding at least one different view element based on the at least one view manager element bound to the user input, wherein the at least one different view element is locally updated based on a new user input, and wherein the view on the client computer is locally updated based on the at least one updated different view element.

26. (canceled)

27. The network computer of claim 25, wherein the processor that executes the instructions enables further actions, comprising:
employing the network computer to locally bind at least one different view element based on the at least one view manager element bound to the user input; and
updating the view on the network computer based on the at least one different view element.

28. The network computer of claim 25, wherein locally binding the user input further comprises:
maintaining a local state of the view manager on the network computer based on the at least one view manager element, wherein the view definition includes conditions for triggering synchronization of the local state with a server state of the view manager on the server computer; and
in response to a synchronization condition being satisfied, synchronizing the local state with the server state of the view manager on the server computer.

29. The network computer of claim 25, wherein locally binding the user input further comprises:
locally binding at least one of data, commands, or notifications from the at least one view element to the at least view manager element.

30. (canceled)

31. The method of claim 1, further comprising:
employing the client computer to locally bind the result associated with at least one other view manager element to at least one other view element based on the at least one defined relationship, wherein the at least one defined relationship is employed to automatically update the at least one other view element employed on the client computer based on the result with the at least one other view manager element executing on the server computer; and
updating the view on the client computer based on the at least one other view element.

32. The method of claim 1, further comprising:
employing data binding to initially populate view elements executing on the client computer based a defined relationship with view manager elements executing on the server computer.

33. The system of claim 10, wherein the processor of the client computer executes the other instructions to enable further actions, including:
locally binding the result associated with at least one other view manager element to at least one other view element based on the at least one defined relationship, wherein the at least one defined relationship is employed to automatically update the at least one other view element employed on the client computer based on the result with the at least one other view manager element executing on the server computer; and
updating the view on the client computer based on the at least one other view element.

34. The system of claim 10, wherein the processor of the client computer executes the other instructions to enable further actions, including:
employing data binding to initially populate view elements executing on the client computer based a defined relationship with view manager elements executing on the server computer.

35. The system of claim 18, further comprising:
wherein the binder logic executing on the processor of the client computer locally binds the result associated with at least one other view manager element to at least one other view element based on the at least one defined relationship, wherein the at least one defined relationship is employed to automatically update the at least one other view element employed on the client computer based on the result with the at least one other view manager element executing on the server computer; and
wherein the view renderer logic executing on the processor updates the view based on at least one other view element.

36. The system of claim 18, wherein the view renderer logic executing on the processor employs data binding to initially populate view elements executing on the client computer based a defined relationship with view manager elements executing on the server computer.

37. The network computer of claim 25, wherein the processor that executes the instructions enables further actions, including:
locally binding the result associated with at least one other view manager element to at least one other view element based on the at least one defined relationship, wherein the at least one defined relationship is employed to automatically update the at least one other view element employed on the client computer based on the result with the at least one other view manager element executing on the server computer; and
updating the view on the network computer based on the at least one other view element.

38. The network computer of claim 25, wherein the processor that executes the instructions enables further actions, including:
employing data binding to initially populate view elements executing on the client computer based a defined relationship with view manager elements executing on the server computer.
